(19) United States
(12) Patent Application Publication
(10) Pub. No.: US 2012/0323816 A1
(43) Pub. Date: Dec. 20, 2012

(54) Method of Strategy Selection for Investment Portfolios

(76) Inventor: Mark A. Clouse, Oceanport, NJ (US)

(21) Appl. No.: 13/329,576

(22) Filed: Dec. 19, 2011

Related U.S. Application Data
(60) Provisional application No. 61/424,808, filed on Dec. 20, 2010.

(51) Int. Cl. G06Q 40/06

(52) U.S. Cl. 705/36 R

(57) ABSTRACT

A method for attaining a financial goal. Using a computer, an individual makes decisions that include whether or not to engage a skilled investor to select an investment mix of asset classes; to then produce a starting investment portfolio by populating the selected investment mix with appropriate assets; and to monitor and adjusting the investment portfolio over time. These determine a path along a decision tree. A computer may then determine the likelihood of meeting the financial goal. The investment mix of asset classes may be determined using computer-generated tables of rolling average, historic returns. The computer may also cross-check an estimated return of the selected mix to ensure that a needed return may be attained. An investment portfolio is then created by populating the asset classes with appropriate assets. The investment portfolio may be monitored and periodically readjusted back to the original mix of asset classes.

### CLAIM OF PRIORITY

This application claims the priority of U.S. Ser. No. 61/424,808 filed on Dec. 20, 2010, the contents of which are fully incorporated herein by reference.

### FIELD OF THE INVENTION

The invention relates to strategies for selecting investment portfolios and, more particularly, to automated strategies that are readily understandable and implementable by relatively inexperienced investors.

### BACKGROUND OF THE INVENTION

Investors, especially relatively inexperienced individual investors, often have difficulty making investment decisions. This is due, in large part, to their being faced with a bewildering array of choices with little or no information or educational material. For instance, the Individual Retirement Accounts (IRA) and 401K investment packages presented to most employees are typically overwhelmingly complex, and often confusing to all but the most experienced investor.

The average investor is, therefore, in need of help in both the actual investment process, and also in determining the approach, or strategy, to investing that best fits their needs, ability and resources.

The present invention is a novel, ingenious and easy to understand method for choosing a strategy to attain a financial goal, and to then implement that strategy. The core of the method involves making the investment process easy to understand and implement by breaking it up into steps that are analogous to the steps taken in selecting, and participating in, a typical diet. By automating appropriate parts of the method, it may be used in the automated selection of investment portfolios, particularly investment portfolios set up to attain a particular financial goal such as 401K retirement investment portfolios or IRA retirement investment portfolios.

### DESCRIPTION OF THE RELATED ART

Relevant art involving automating investment strategies and asset portfolio selection includes:

U.S. Pat. No. 6,839,685 issued to Leistensnider, et al. on Jan. 4, 2005 entitled “Method and system for creating a portfolio of stock equities” that describes a computer-implemented method and system for selecting stock equities for inclusion in a strategic investment portfolio includes identifying stocks making up a preselected index, and analyzing the stocks for dividends, earnings per share, earnings growth, market capitalization, and economic sector, according to predetermined criteria selected according to the investment strategy. A sorted list of acceptable stocks is then created from which the portfolio is assembled.

U.S. Pat. No. 6,996,539 issued to Wallman on Feb. 7, 2006 entitled “Method and apparatus for enabling smaller investors or others to create and manage a portfolio of securities or other assets or liabilities on a cost effective basis” that describes a computer implemented method using aggregation for enabling a user to create and trade a plurality of market tradable assets or liabilities as a single, customizable investment portfolio. An embodiment of the invention includes determining, based on an order to trade a portfolio from a user, a plurality of distinct market tradable assets or liabilities to be transacted in a market for each of the distinct assets or liabilities in a plurality of transactions for the user, aggregating the plurality of transactions for the user with a plurality of transactions for one or more other users over an applicable characteristic of the plurality of assets or liabilities, wherein the aggregating includes aggregating single shares, odd lots and/or fractional shares using a computer, and executing one or more trades based on the aggregating to implement the order to trade the portfolio.

U.S. Pat. No. 7,050,998 issued to Kale, et al. on May 23, 2006 entitled “Investment portfolio construction method and system” that describes a method and a system for the optimal allocation of investment funds to construct an investment portfolio by using a two-segment, risk-averse utility function, where the first segment is a log-utility function indicative of the portfolio holder's utility for positive rates of return and reflects the portfolio holder's desire for maximizing portfolio growth, and the second segment is a power-utility function with a zero or negative power indicative of the degree to which the portfolio holder is averse to losses. An optimization algorithm determines the optimal investment weights for the assets in the investment portfolio to maximize the portfolio's expected utility, which is based on the two-segment utility function. Computer software includes modules for carrying out the optimization to determine the optimal investment weights for the assets and to thereby construct the investment portfolio. The computer software is in the form of codes executed by a processor.

U.S. Pat. No. 7,149,713 issued to Bove, et al. on Dec. 12, 2006 entitled “System and method for automating investment planning” that describes a computerized scheme that automates investment planning for a client. In the scheme, data regarding the client's desired asset allocation, current asset portfolio and preferred domain are input into a computer or processor. This data are used to automatically generate financial transaction recommendations for modifying the client's current asset portfolio to reach as close as possible to the desired asset allocation and the preferred domain. The recommendations include specific recommendations for selling amounts of selected current assets and specific recommendations for buying amounts of one or more investment funds. The recommendations are displayed on a summary report for review by the client or the client's financial manager, or the recommendations are electronically communicated to a trade execution computer which automatically performs the necessary transactions to execute the buy/sell recommendations. The recommendations are selected in a manner which minimizes the tax impacts and transaction costs of potential sell transactions.

Various implements are known in the art, but fail to address all of the problems solved by the invention described herein. One embodiment of this invention is illustrated in the accompanying drawings and will be described in more detail herein below.

### SUMMARY OF THE INVENTION

The present invention is a method for choosing a strategy to attain a financial goal, and for implementing that strategy. In a preferred embodiment of the method, the investor may be prompted by an automated device to make a series of decisions. These decisions may include selecting whether or not to engage a skilled investor for each of a series of tasks that are framed to be analogous to the tasks involved in selecting and following a diet. The tasks may include, but are not limited to, selecting an investment mix of asset classes and producing a starting investment portfolio by populating the selected investment mix of asset classes with appropriate assets. In a preferred embodiment, the assumption may be made that the entity selected to produce the starting investment portfolio, will also monitor the investment portfolio.

Once these decisions make are made, an investment path along a decision tree may be determined. A suitably programmed computer may then assess a likelihood of attaining the financial goal using the investment path determined by the investor's decisions as to who will perform the necessary tasks.

The investor may then select the investment mix of asset classes. In a preferred embodiment, this selection may be done using a computer generated display of historic returns of a variety of mixtures of asset classes. The mixtures preferably have at least two different percentages of a first and a second asset class. The historic returns are preferably averages calculated over rolling periods of time. In a most preferred embodiment, they are averages calculated over rolling one year periods, rolled forward a month at a time. The display may, for instance, be in the form of table elements containing a representation of the historic returns of the mixtures of asset classes. Each table element may also have representations of a best return and a worst return, and may include pictorial or graphical elements.

The computer may also be suitably programmed to perform a cross-check. This may, for instance, include calculating an estimated return of the selected investment portfolio over a time-to-goal time period, and then determining if the estimated return corresponds to a needed return.

The investment portfolio may be monitored over the investment period by, for instance, periodically re-balancing the investment portfolio to conform it to the initially selected mix of asset classes. The rebalancing may, for instance, be performed at a set time period, such as, but not limited to, once every three months, or when a market index for an asset class changes by, for instance, 10% or more from the last time a rebalancing was performed.

Therefore, the present invention succeeds in conferring the following, and others not mentioned, desirable and useful benefits and objectives.

It is an object of the present invention to provide a method for investors to made better investment decisions.

It is another object of the present invention to provide an investor with easily understood information regarding investment packages such as, but not limited to, IRA and 401K packages.

Yet another object of the present invention is to provide investment information that is educational.

Still another object of the present invention is to provide information on strategies to attain financial goals.

### BRIEF DESCRIPTION OF THE DRAWINGS

FIG. 1 shows a flow diagram of selected steps in a method of choosing a strategy for investment selection in accordance with the present invention.

FIG. 2 shows a flow diagram of selected steps in a method of decision making for investment selection in accordance with the present invention.

FIG. 3 shows a flow diagram of selected steps in a decision tree for investment selection in accordance with the present invention.

FIG. 4 shows an example of a work sheet for investment selection in accordance with the present invention.

FIG. 5 shows an example of a display of historic returns for investment selection in accordance with the present invention.

### DESCRIPTION OF THE PREFERRED EMBODIMENTS

The preferred embodiments of the present invention will now be described with reference to the drawings.

Identical elements in the various figures are identified with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto.

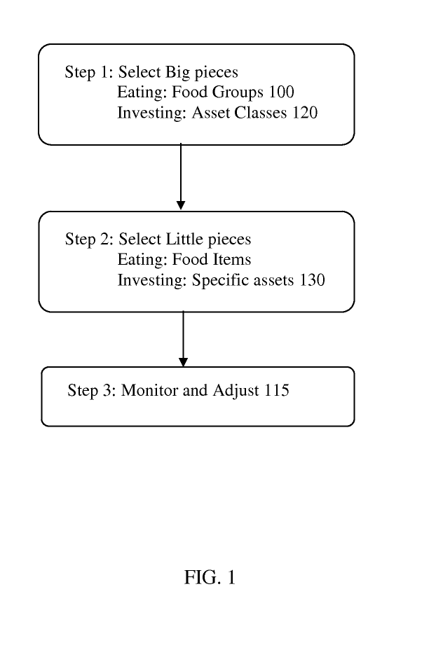

FIG. 1 shows a flow diagram of selected steps of a method of choosing a strategy for investment selection in accordance with the present invention.

The investment portfolio selection process may be thought of as analogous to selecting food when following a diet. In a preferred embodiment, the selection process typically has three steps.

In step 1 the “big pieces” are selected.

In a diet, the big pieces may be food groups. The food groups may be categories of food such as, but not limited to, meat, vegetables, dairy products, fats and starches, or some combination thereof. The selection may include which food groups to eat, and what percentage of each food group 100 to include in the diet. The percentage may be determined by measurements such as, but not limited to, a number of servings, a calorie content, a weight or some combination thereof.

In an investment portfolio, the analogous big pieces may be asset classes 120 such as, but not limited to, stocks, bonds, cash, real estate, commodities, stable value funds, or some combination thereof. The selection may include which asset classes to include in the investment portfolio, and what mixture, or percentage, of each type of asset classes to include in the investment portfolio. Typically, the percentage of an asset class may be determined as the current, or market, value of the assets making up that asset class expressed as a percentage of the total current, or market, value of all the assets of the investment portfolio.

In step 2 the “little pieces” are selected. In a diet, the little pieces may be actual portions of food. The diet may then be constructed as a series of menus having portions of food. The menus may for instance be constructed so that the total amount of the various portions of food of a particular food group, over a given period, amount to the correct proportion of that particular food group in the total diet.

For instance, one of the diet food groups may be “Meat”, and it may be required to be only 10% of all the food consumed in the diet over a period of a week. The little pieces may then be portions of types of meat, such as, but not limited to, beef, pork, chicken, fish, or some combination thereof. The menus may then be constructed so that a variety of dishes having beef, chicken and fish are eaten, so that the total number of servings of meat amount to 10% of all the servings of food eaten that week.

In an investment portfolio the analogous small pieces may be appropriate assets. The investment portfolio may be created by, for instance, populating each of the asset classes with the correct amount of appropriate assets of that class. The correct amount may be a percentage. That percentage may, for instance, be obtained by expressing the total current, or market value, of all the assets of a particular class of assets as a percentage of the current of market value of all the assets in the investment portfolio.

For instance, one of the elements of an investment mix of asset classes may be “Stocks”. The little pieces may then be appropriate stock assets. Each of these appropriate assets 130 may be a number of shares in a particular stock or stock fund such as, but not limited to, shares of a specific company, shares of a large cap stock fund, shares of an international stock fund, shares of a value stock fund or some combination thereof. The selected mix of asset classes may be such that Stocks should always constitute 10% by current value of the total current value of the investment portfolio.

In step 3 the effects of the diet or the investment portfolio are monitored over time, and adjusted as necessary.

In a diet, the monitor and adjust 115 step may consist of periodic reviews such as, but not limited to, weighing on a weekly schedule along with returning to step 2 to reselect the portions of food.

In an investment portfolio, the monitor and adjust step may also consist of periodic reviews such as, but not limited to, re-balancing the investment portfolio. Rebalancing an investment portfolio may consist of calculating the current value of each asset in the portfolio to determine both the total current, or market, value of the portfolio and the total current, or market value, or each of the asset classes in the portfolio. A determination may then be made of what the current mix, or representation by current value of each asset class as a percentage of the total current value of the portfolio is. If the mix of the asset classes is different from that initially selected, individual assets may be sold and bought so as to re-align, or conform, the current mix of asset classes to the initially selected mix.

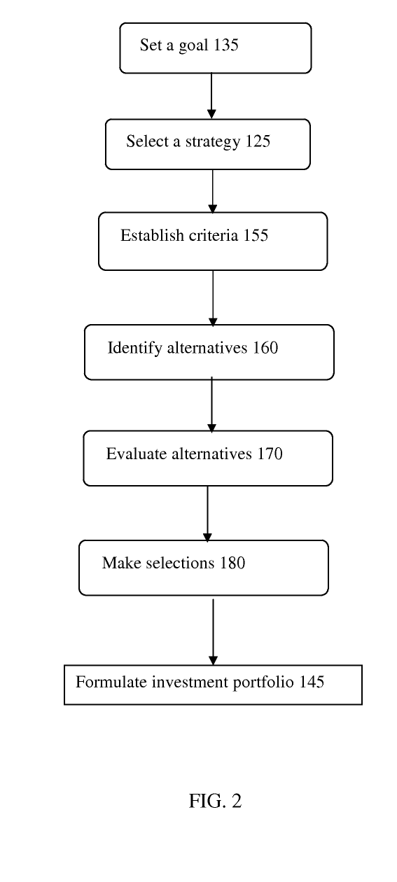

FIG. 2 shows a flow diagram of selected steps of a method of decision making for investment selection of the present invention. The decision making method may, for instance, be used in steps 1 and step 2 of the process outlined in FIG. 1.

For instance, in step 1 when selecting an investment mix of asset classes, a first step may be to set a goal 135. This may be a financial goal such as, but not limited to, having sufficient retirement money to last 20 to 30 years.

A next step may then be to select a strategy 125. In selecting an investment mix of asset classes, the step of selecting a strategy 125 may include deciding to follow one of the well known methods of selecting mixes of asset classes such as, but not limited to, a risk based method, an age-based method, a time-based method, a modern portfolio theory method or some combination thereof.

A next step may then be to establish criteria 155. Having selected a strategy 125, establishing criteria 155 may, for instance, include setting limits on one or more of the strategy elements. For instance, if a risk based strategy is selected, establishing criteria 155 may, for instance, include deciding whether the selection will be alpha focused, i.e., will seek assets whose anticipated excess returns are higher than industry benchmarks and, if so, the specific range of anticipated excess returns that will make assets eligible for inclusion. Alternately, if the risk strategy is to be downside risk aware, i.e., seeking assets that are predicted to outperform their benchmarks especially in down markets, then the criteria that may be established include the range of anticipated outperformance that will make assets eligible for inclusion in the portfolio.

A following step may be to identify alternatives 160 that are appropriate to the strategy selected and that meet criteria established within that criteria.

Having identified alternatives, the next step may be to evaluate the alternatives 170.

Having evaluated alternatives 170, the subsequent step is to then make selections 180 resulting in the formulation of an investment portfolio 145.

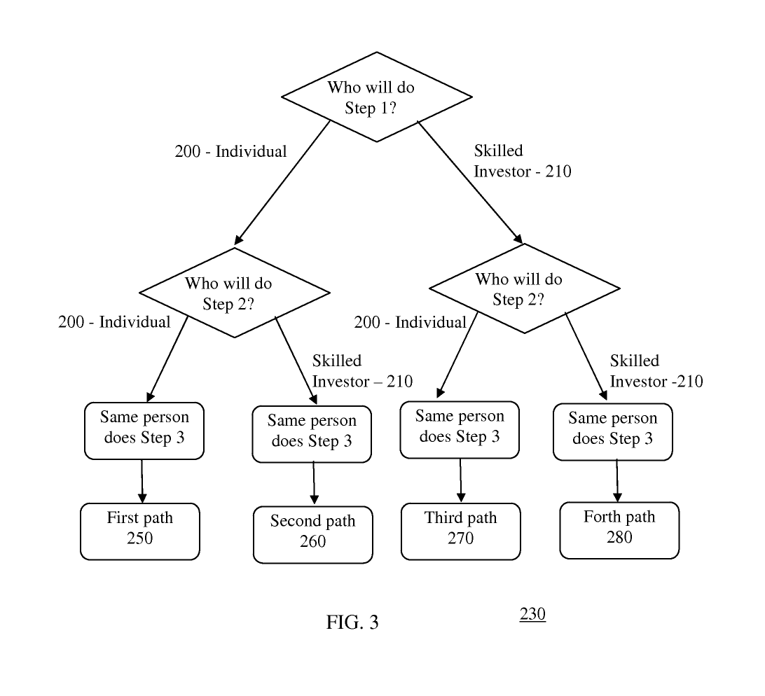

FIG. 3 shows a flow diagram of selected steps of a decision tree for investment selection of the present invention. The decision tree 230 may represent a way of choosing a strategy to attain a financial goal.

By using the decision tree 230, an investor setting up an investment portfolio may investigate the consequences of selecting who does the work at each stage of the process shown in FIG. 1.

So the first decision point in the decision tree 230 is to elect who will do the work entailed in Step 1, i.e., the investor may decide whether to engage a skilled investor to do the work of selecting an investment mix of asset classes or whether the investor will do the work involved in that step themselves.

The second decision point in the decision tree 230 is to elect who will do the work of step 2, i.e., whether to engage a skilled investor to do the work of selecting an investment mix of asset classes or whether the investor will do the work entailed in that step themselves.

In a preferred embodiment, the assumption may be made that whoever does Step 2 of the process will also perform the work involved in Step 3.

As a result of the decisions made above, the investor may have traversed the decision tree 230 along one of four paths.

A computer may then be used to provide the investor with an assessment of how likely they are to reach their financial goal using their selected investment path.

For instance, if a first path 250 is selected, in which the investor elects to do the work of both steps themselves, the computer may rate this as the most difficult path as to do it requires the individual 200 to have advanced investing skills, access to analytical tools, an indifference to gains and losses, and a great deal of time. The first path 250 may, therefore, be rated as offering a good chance of attaining poor results, i.e., a low probability of reaching the financial goal.

Selection of a second path 260, in which the individual elects to do the work of step 1 themselves and to then engage a skilled investor to do the work of steps 2 and 3, may lead to a different probability of success. The computer may, for instance, rate this as the easiest path as it requires the individual to only have minor investment skills The second path 260 may, therefore, be rated as offering the best chance of getting very good results, i.e., the highest probability of reaching the financial goal.

The computer may, for instance, rate the election of a third path 270 in which the individual 200 elects to do the work of steps 2 and 3 themselves, but to engage a skilled investor 210 to do the work of step 1, as a very difficult path. This assessment may be arrived at because this third path requires the individual to have advanced investing skills, access to analytical tools, an indifference to gains and losses, and a great deal of time.

The third path 270 may, therefore, be rated as offering a good chance of attaining poor results, i.e., a low probability of reaching the financial goal.

The computer may rate the selection of a forth path 280 in which the individual elects to engage a skilled investor to do the work of all three Steps 1, 2 and 3 as the easiest path. This assessment may be arrived at because the forth path 280 requires the individual to only have minor investment skills.

The forth path 280 may, therefore, be rated as offering the best chance of getting very good results, i.e., a high probability of reaching the financial goal.

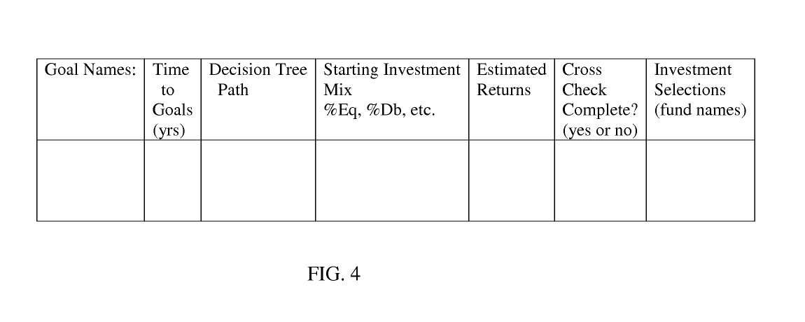

FIG. 4 shows an example of a work sheet 300 for investment selection in accordance with the present invention. The exemplary worksheet may be designed to help an individual and/or investor to set and reach a financial goal by means of an investment portfolio having an investment mix of asset classes.

The worksheet may for instance, require an individual and/or investor to name their financial goal, and then to record a time-to-goal time period and the path of the decision tree that they have decided to adopt. They may also record their investment mix of asset classes decided upon, and the estimated return that investment may result in. They may also use the worksheet to record whether or not a cross-check was successful, i.e., that the selected investment portfolio of appropriate assets will provide an estimated return that matches or exceeds a needed return. They may also use the worksheet to record the appropriate assets of their investment portfolio, such as, but not limited to, the names of investment funds.

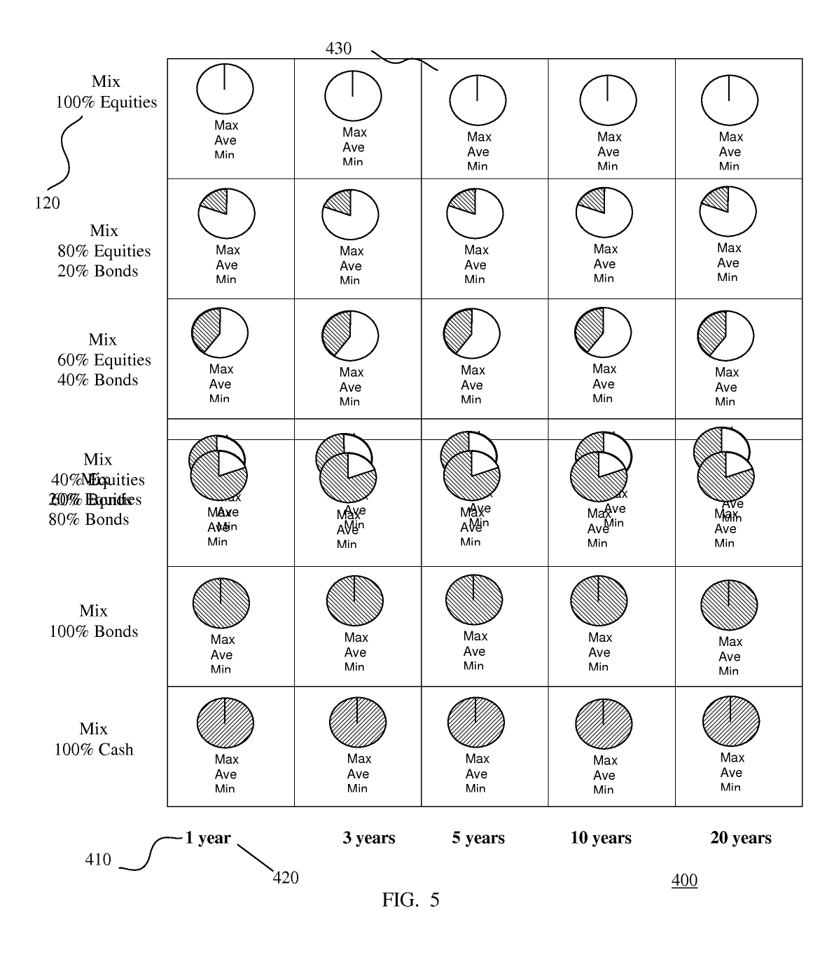

FIG. 5 shows an example of a display of historic returns for investment selection in accordance with the present invention. The display of historic returns may be used in determining an appropriate investment mix of asset classes 120.

The display of historic returns 400 may be generated from a database of historic investment results by an appropriately programmed computer. In a preferred embodiment, the results of the computer processing may be displayed as a table 430 in which the rows may correspond to an investment mix of asset classes 120 while the columns may represent investment periods of time 410. The asset classes 120 may include, but are not limited to, stocks, bonds, cash, commodities, real estate or stable value assets, or some combination thereof.

The rows of investment mix of asset classes 120 may each correspond to a mix of asset classes, with each row representing returns over different investment periods of time 410 for a mix having a percentage of a one or more asset classes.

Each element of the table 430 of a display of historic returns 400 may, for instance, display information such as, but not limited to, a percentage mix of the assets, and the returns over the given investment period of time 410, and the returns may include, but are not limited to, an average return, a median return, a maximum or best return, a minimum or worst return or some combination thereof.

The information in each element of the table 430 may be displayed alphanumerically, pictorially or graphically using indicia or graphs such as, but not limited to, pie charts, bar charts and line charts or some combination thereof.

The returns displayed are preferably calculated over a rolling period of time 420. In a more preferred embodiment, the rolling period of time 420 may be a year that is rolled forward a month at a time.

Having selected an investment mix of asset classes 120, the investment portfolio 145 may be created by populating the selected investment mix of asset classes 120 with appropriate assets 130. This may be done using the same steps shown in FIG. 2.

In populating the investment portfolio, i.e., step 2 of FIG. 1, a first step may be to set a goal 135. This may be a goal such as, but not limited to, maximizing returns with a minimum level of risk.

A next step may then be to establish criteria 155. In selecting appropriate assets 130, the step of establishing criteria 155 may include following one of the well known strategies of selecting assets such as, but not limited to, a value or growth as determined by the price/earning (P/E) ratio, with high P/E stocks representing growth, and low P/E stocks represent value. Establishing criteria 155 may also include, but is not limited to, setting parameters for historical return, management style and investment philosophy or some combination thereof.

A following step may to then identify alternatives 160.

Having identified alternatives, the next step may be to evaluate the alternatives 170.

These two steps 160 and 170 may be used to populate the selected investment mix by, for instance, identifying at least two distinguishable assets for each asset type, and then determining how the identified assets rank against each other, using one or more of the predetermined criterion selected previously.

Having evaluated alternatives 170, the subsequent step is to then make selections 180, i.e., to decide on which of the ranked alternatives assets 130 to include in the investment portfolio 145.

Having made the selections of appropriate assets and populated the investment portfolio, the investment portfolio then has to be monitored and adjusted.

One method of monitoring and adjusting may be re-balancing. This is a monitoring method in which the selected appropriate assets are revalued periodically at, for instance, their current market value. Based on that valuation, changes may be made to the portfolio by, for instance, acquiring or disposing of, various assets in order that portfolio is rebalanced, i.e., the investment mix of asset classes 120 originally selected for the portfolio is reestablished based on current market value.

The rebalancing may be done periodically. In a preferred embodiment, rebalancing is performed at least once every three or four months, or when a market index for an asset class changes by 10% or more from the last time a rebalancing was performed, or both.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A method for choosing a strategy to attain a financial goal, comprising:
selecting whether or not to engage a skilled investor to select an investment mix of asset classes;
selecting whether or not to engage a skilled investor to create an investment portfolio by populating said selected investment mix of asset classes with appropriate assets and to monitor said investment portfolio over an investment period of time;
determining an investment path along a decision tree using said selections; and
determining, using a suitable programmed computer, an assessment of a likelihood of meeting said financial goal using said investment path.

2: The method of claim 1, further comprising selecting said investment mix of asset classes.

3: The method of claim 2 wherein selecting said investment mix of asset classes further comprises generating, via said computer, a display of historic returns of mixes of asset classes over an investment period of time, each of said mixes of asset classes having a different percentage of a first asset class.

4: The method of claim 3 wherein said historic returns are averages calculated over rolling periods of time.

5: The method of claim 4 wherein said rolling periods of time comprise a rolling one year period, rolled forward a month at a time.

6: The method of claim 3 wherein said display of historic returns is a table having elements containing a representation of the historic returns over an investment period of time for at least two distinguishable asset class mixtures as a function of at least two investment periods of time.

7: The method of claim 6 wherein said table elements further provide representations of a best return and a worst return for each table element, and wherein at least one of said representations is pictorial or graphical.

8: The method of claim 2 further including selecting a time-to-goal time period, and performing, via a computer, a cross-check to determine if an estimated return corresponds to a needed return.

9: The method of claim 2 wherein said asset classes are one of stocks, bonds, cash, commodities, real estate or stable value assets, or some combination thereof.

10: The method of claim 2 further comprising creating said investment portfolio by populating said selected investment mix of asset classes with appropriate assets.

11: The method of claim 10 wherein populating said selected investment mix further comprises identifying at least two distinguishable assets for each asset type, and choosing the one that best matches a predetermined criterion.

12: The method of claim 10 wherein monitoring further comprises re-balancing said appropriate assets to conform to said selected mix of asset classes.

13: The method of claim 12 wherein said rebalancing is performed at least once every three months, or when a market index for an asset class changes by 10% or more from the last time a rebalancing was performed.
